(19) United States
(12) Patent Application Publication
(10) Pub. No.: US 2011/0307451 A1
(43) Pub. Date: Dec. 15, 2011

(54) System and method for distributed objects storage, management, archival, searching, retrieval and mining in private and public clouds and deep invisible webs

(75) Inventors: Abderrahman Aba El Haddi, Chaska, MN (US); Anass Taouil, Jerada (MA); Jeffrey Brian Marckel, Alliance, OH (US); Zakaria Baani, Eagan, MN (US)

(73) Assignee: EnduraData, Inc,, Eden Prairie, MN (US)

(21) Appl. No.: 12/802,610

(22) Filed: Jun. 10, 2010

(51) Int. Cl. G06F 17/30

(52) U.S. Cl. 707/673; 707/722; 707/E17.005; 707/661; 707/769; 707/E17.014

(57) ABSTRACT

A method and system for efficiently archiving and retrieving objects using a distributed network of devices wherein the users define attributes, distribution lists, subscribers to content and objects. The objects can be archived, searched for, tagged, indexed, attributed, restored and mined. Objects have signatures that indicate where they came from and where they are stored.

Attributes include system attributes which may geo-reference objects. Attributes and signatures can be associated with alerts and notifications to subscribers who register interest in receiving alerts about objects, object signatures or attributes.

### FIELD OF THE INVENTION

This document pertains generally to flexible distributed facilities for storing, archiving, managing, searching, retrieving, sharing and mining data objects and documents, and more particularly, but not by way of limitation, to a SYSTEM AND METHOD FOR DISTRIBUTED OBJECTS STORAGE, MANAGEMENT, ARCHIVAL, SEARCHING, RETRIEVAL AND MINING IN PRIVATE AND PUBLIC CLOUDS AND DEEP INVISIBLE WEBS

### BACKGROUND OF THE INVENTION

Users and companies need to manage, store, search, access, tag content of different types. They also need to be alerted when content of interest to them matches search criteria. Furthermore, some systems instead of individuals may register interest in certain content and run certain processes when content matches certain characteristics. The content can be simple documents generated from a word processor, laboratory equipment, satellite images, motion sensors, video surveillance, corporate or individual brand monitors on public or private systems, screen dumps, financial data, videos images, emails or email attachments, telephony recordings, streams of data such as from a telephone conversation, real time feeds of audio, video or backup snapshots of a computer or a device, application or system logs, various digital signal data, etc. We will refer to these data throughout this document interchangeable as objects, data, data objects, content, digital assets, documents or words describing data stored or generated through some sort of input/output.

Traditional data archival and content management systems have one or more limitations such as:
1. Having a single point of control and failure.
2. Having a central catalog comprised of indices of archives or archives and their storage locations.
3. Having access only by name, index or address (full object name) and not by signature
4. Not having a means of adding new content tags, content descriptions, new signatures.
5. Not providing facilities for restricting or allowing access to only subsets of objects.
6. Not providing a means of adding signatures, tags or meta data to only subsets of objects.
7. Geared toward static content addressable storage
8. Not providing facilities for reverse mappings between object signatures and objects names or addresses because they used location independent signatures such as md5.
9. Not being able to track or trace back digital assets once they leave a single locale or enterprise, therefore not capable of showing sources of data leaks.
10. Not providing adequate facilities for indexing, reindexing, signing or resigning objects.
11. Not providing flexible facilities for establishing associations between content, content signatures.
12. Not providing facilities for retrieving one or more objects using one or more tags or signatures.
13. Not providing data mining for discovery of patterns or links between data objects, creators or mutators of objects (producers) or users of objects (consumers) or location of objects (storage).
14. Not making associations between catalog index, content signatures or meta data signatures or signatures of signatures for the purpose of object storage, retrieval, mining and tracking.
15. Not having a way to recover objects if a central system fails or a storage system fails.
16. Not supporting indexing, storage and tagging of stream data such as video, audio which may not have a priori fixed size.
17. Not having an integrated means of notifying processes or subscribers when and objects' state changes such as addition of new objects, addition of attributes or modifications of data.
18. Having a barrier between private storage and public storage, therefore an application can only use public storage such as the one available in public cloud or use only private storage such as available in the form of direct attached storage, SAN, NAS, NFS, CIFS or private clouds.

Furthermore, security concerns have limited wide access to archives except through the web, ftp or other protocols which do not lend themselves to deep mining of the deep invisible web and enterprise information assets.

Several archival and storage systems have been proposed for archival purposes, for example, in U.S. Pat. No. 6,574,640 Stahl (2003) discloses a central archive system that allows users to search and retrieve data from many remote archive servers. In the system and methods described used several archive servers, only one is marked as the current server, therefore accessing only one at a time. Furthermore, if the central archive system is down, there is no way of accessing any of the remote external archives unless you connect directly to them one by one and use disparate methods to access the data, therefore requiring applications and data consumers to provide support for all heterogeneous external systems and rendering the concept of a central system useless. All indices are stored and accessed through the central archival system. The only items that the user can receive from a central server is a catalog of documents and a list of addresses that contain the data. There is no meta data, system data and there is no way to add new catalogs or new tags or attributes to label the archived data for purposes of allowing flexible searches, searches by content, searches by content signatures or to establish links between content, document providers, document sources, document producers or document owners. Furthermore no meta data about the documents is stored on the central archive system and the retrieval of data does not impose restrictions on the retrieval. A user can either have access to a document in its entirety or have no access. Although flexible to manufacture and to provide a unified access to heterogenous archive systems, the system is incapable of performing any data mining, adding tags or of protecting portions of documents while allowing access to other portions of the document, the unavailability of the central archive system renders the system totally useless for an application, process or apparatus designed to rely solely on the central server. Furthermore, the central archive server does not log access to the central archive server. The central server relies on manual configuration and has no way of automatically discovering remote archive servers or of services provided.

In U.S. Pat. No. 5,402,474, Miller et al. combined a workstation and server on the same token-ring network to archive telephone calls only. The system uses a single central archive server that is also subject to loss of access in case the said server becomes unavailable due to failure or communication problems. The data access is also limited to the local network. Furthermore, the system described in the said patent suffers from the same weaknesses as U.S. Pat. No. 6,574,640 to Stahl (2003).

U.S. Pat. No. 6,807,632 to Carpentier et al. 2004) used a location independent identifier to identify a group of objects. The identifier is the MD5 hash of a at least a portion of the content and of the metadata. In order to find the objects a multicast or broadcast is used. The draw backs of this technique comprise at least the following:
(a) The object identifiers do not have a reference to where the objects are stored since they are location independent. Which renders this method either useless or expensive in the case of dispersed and distributed storage providers on multiple networks or network of networks such as the interne or private clouds.
(b) The said method has a few more steps of generating ids for groups of objects and their metadata.
(c) The meta data is generated when an object is stored. This renders the system inflexible, since users can generate new meta data and may need to add tags and new attributes without generating new objects. The methods used do not provide any way to add new tags or replace older tags or metadata.
(d) The object has one unique metadata associated with each object id. Therefore multiple users or devices that have the same object will always have the same exact meta data unless a new object or grouping of the asset is used. For example if the object stored is a video, the meta data associated with the video is fixed. If two users restore the same video they will have the same meta data associated with the video. If user 1 is on a private network and he restores the said video to his laptop. That video will have the original meta data associated with it.
(e) The method is focused on assets of fixed sizes and does not disclose how to deal with continuous streams of data where no one knows when a stream will end.
(f) The system and methods described in the said patent do not provide any methods for making associations between different assets or groups of assets, the meta data and user attributes to allow for dynamic discovery and mining without additional applications or programming.
(g) The meta data used is simply system meta data such as file creation or modification times, permissions, owner etc.

U.S. Pat. No. 7,627,726 to Chandrasekaran and Abnous (2009) associates content with a retention period for the purpose of deleting the content and the meta data after the retention period is reached. It does not provide a way for relocating content instead of deleting it or other user desired actions. The system uses one or more storage servers to store the object and meta data at the time the object is stored and created. The methods described in the said patent suffer from at least the following shortcomings:
(a) The objects are of fixed size and do not support streams of data.
(b) The system described gives a new id for each stored object and does not keep any reference counts for the objects stored. Access to meta data and data may also fails if the system fails.
(c) No links or associations are created between objects to establish any relation between stored objects created at a later or earlier time.
(d) The method does not provide a way to perform any notifications necessary for sharing information for operational purposes and or for taking specific actions pre-loaded by subscribers to information.

Many businesses and governmental agencies have branches across the country or the globe. Their employees are mobile and constantly need to store, archive, retrieve, search, manage, mine, share content between people or processes no matter where they are and no matter where data is stored as long as they have the proper connectivity and access rights. Furthermore data's value may be augmented by adding attributes to it and mining it to discover new patterns or evidence. These same organizations also need to establish links between data, users, processes, producers and consumers of data. An audit trail is important when retrieving or mutating data. Several institutions have private clouds already and may prefer to use these investments alone or in conjunction with other public clouds.

In general there is a need for making use of existing investments in storage, allowing users to find relevant data to their searches and to mine content to establish links between data objects, data producers or data consumers and to take specific actions such when a link or information is deemed relevant to certain operational aspects of the business or agency. Furthermore, scalability, performance, reliability and reduced cost of operation and reduced time to discovery are all critical.

### SUMMARY OF THE INVENTION

Generally a method and apparatus are disclosed for storing, signing, retrieving, searching, managing, indexing and mining content across multiple devices and notifying subscribers to the content.

The object of the present invention is therefore to provide a unified method and system of distributed storage, storage data management for archive, discovery or other operational purposes. The solution according to the invention uses a set of distributed cooperative processes, tools and APIs for efficient storage, retrieval, search and mining of data objects such as files, file archives, database dumps, logs, streams or other like digital assets. The present invention mirrors data between one or more devices to allow faster searches and provide redundancy in case one or more devices are lost or if subscribers wanted data delivered to them for sharing purposes. Once data is replicated digital asset signatures are changed to reflect where the objects can be found and one or more devices are notified of such changes.

Our invention will make use of the existing private or public clouds infrastructure or use new clouds such as the ones available as a service to maximize the use of distributed object storage and to solve several problems discussed in previous sections. Furthermore, mobile applications such as the ones that run on smart phones, personal communication devices, telemetry devices can contribute geo-referenced content to companies automatically. The content and system attributes are added either automatically or manually and used to augment other data object values. Each object has default storage system attributes, local system attributes (the source), user selected attributes and tags, meta data and one or more list of subscribers and actions to perform when new object is stored or new attributes are discovered. Each object stored is indexed using various fragments of the digital signature. A signature is location dependent and has a plurality of fragments. The fragments include at least a source fragment signature to represent where data originated from, a storage location fragment signature to represent where the data is stored, and the object checksum signature to represent the content. Each list of subscribers has a list of notifications and means of notifications such as an email, an SMS or a process and one or more parameters for the external process. The apparatus has a set of tools and means for communicating between the local and distributed elements of the system.

Further advantages of various aspects will become apparent from a consideration of the ensuing detailed description and drawings.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. The present invention is described below by reference to the following drawings, descriptions and embodiments in which:

FIG. 1A shows the architecture of the distributed system and the various devices and components suitable for the implementation of the various embodiments of the present invention.

FIG. 1B shows an example of the partition of the distributed storage space into local storage pools (LSP).

FIG. 1C shows the groupings of local storage pools into logical global storage pools (GSP).

FIGS. 2A through 2B illustrates a process suitable for embodiments for steps 308, 310 and 320

FIG. 3 is a flow chart that illustrates one embodiment of a device that is archiving data to one or more Storage Data Devices (SDD).

FIG. 4 illustrates one embodiment of a storage data device that services requests to archive objects and generate notifications to Meta Data Devices (MDD) and action listeners.

FIG. 5 illustrates one embodiment which processes notifications and alerts.

FIG. 6 illustrates one embodiment of a source device, discovering storage data devices, searching and retrieving objects from multiple storage data devices.

FIG. 8 illustrates one embodiment of a source device searching and updating metadata, user attributes or system attributes and its local cache.

### DETAILED DESCRIPTION OF THE INVENTION

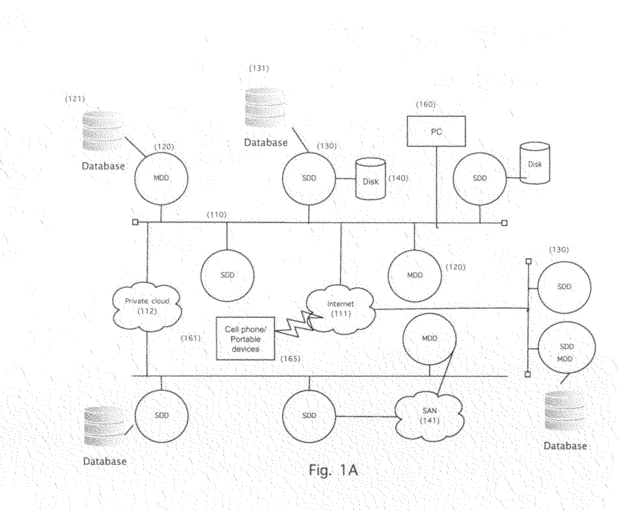

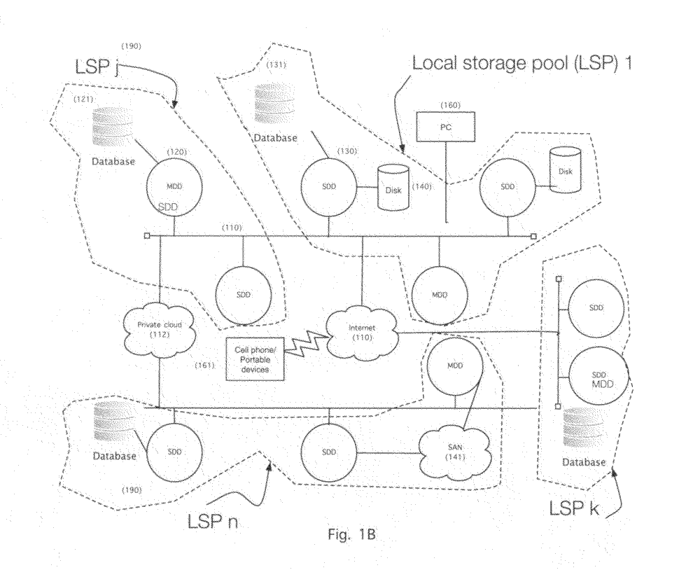

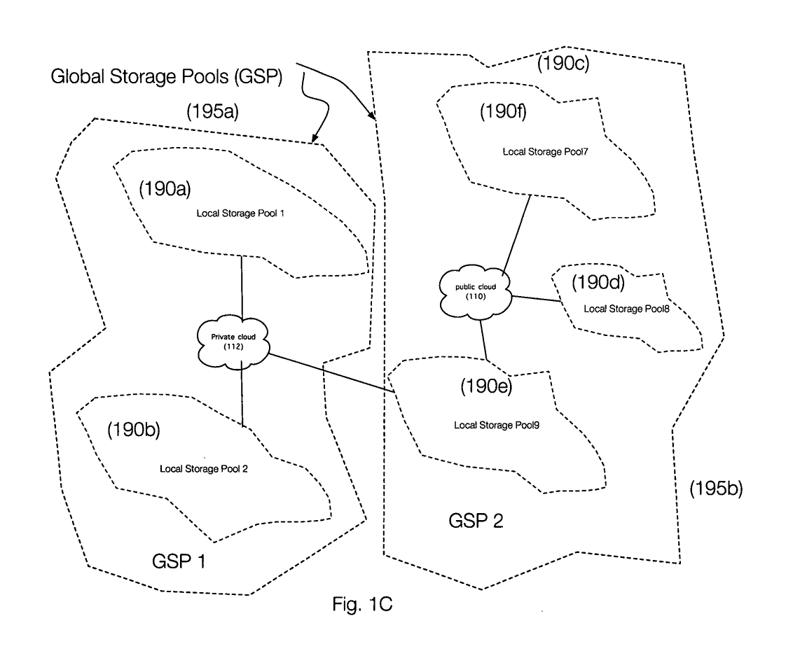

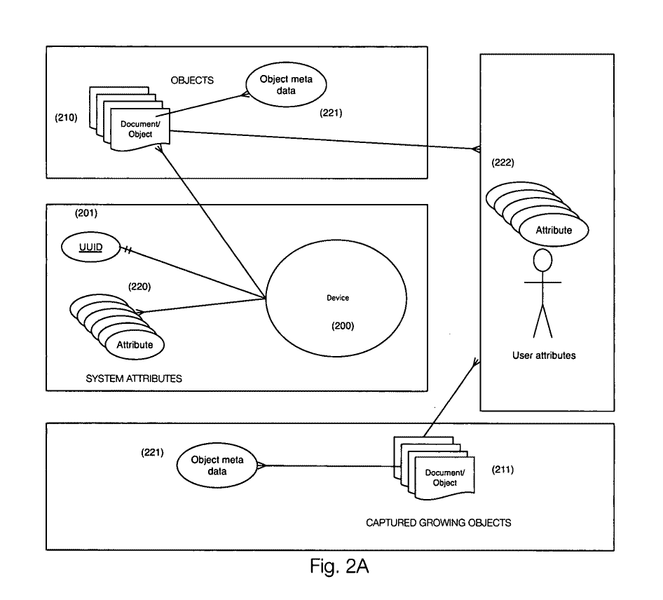

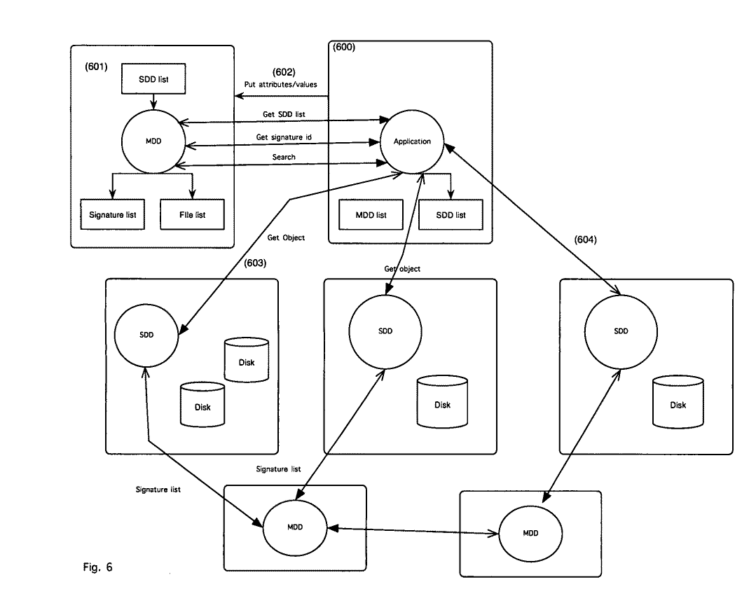

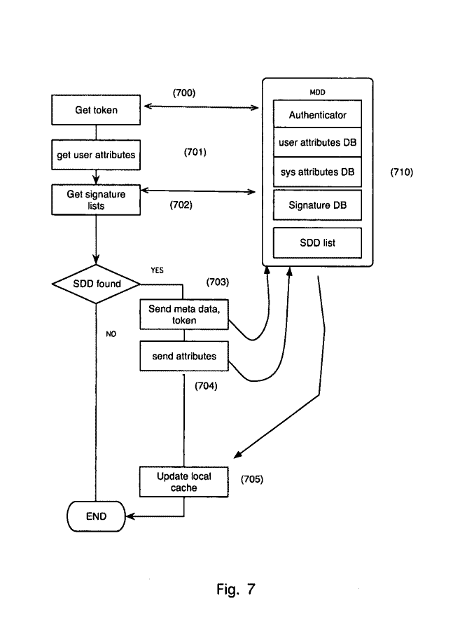

FIGS. 1 through 7 show the distributed storage architecture according to the present invention for archiving, searching and distributing data and objects and notifications to registered content subscribers using devices capable of input and output through various communication networks.

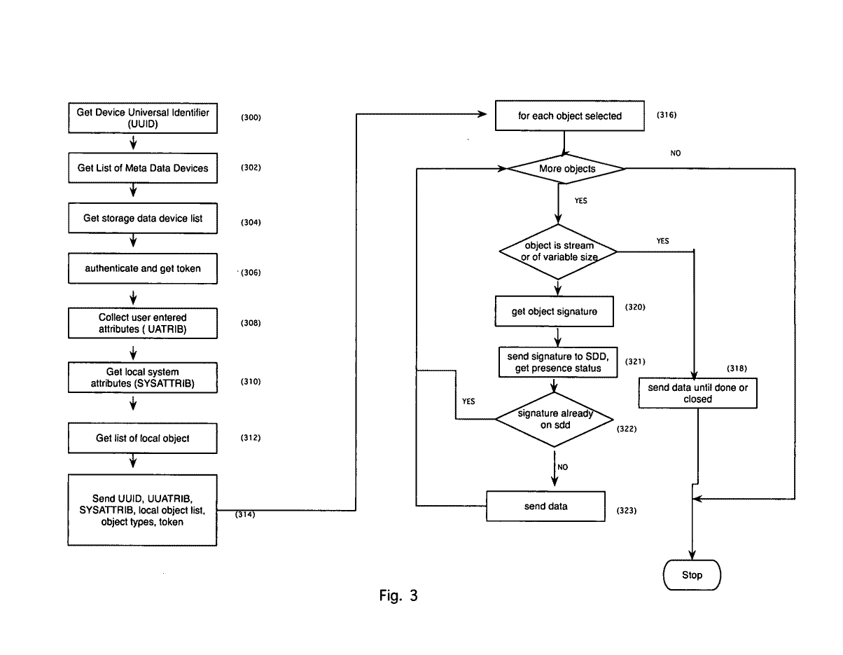

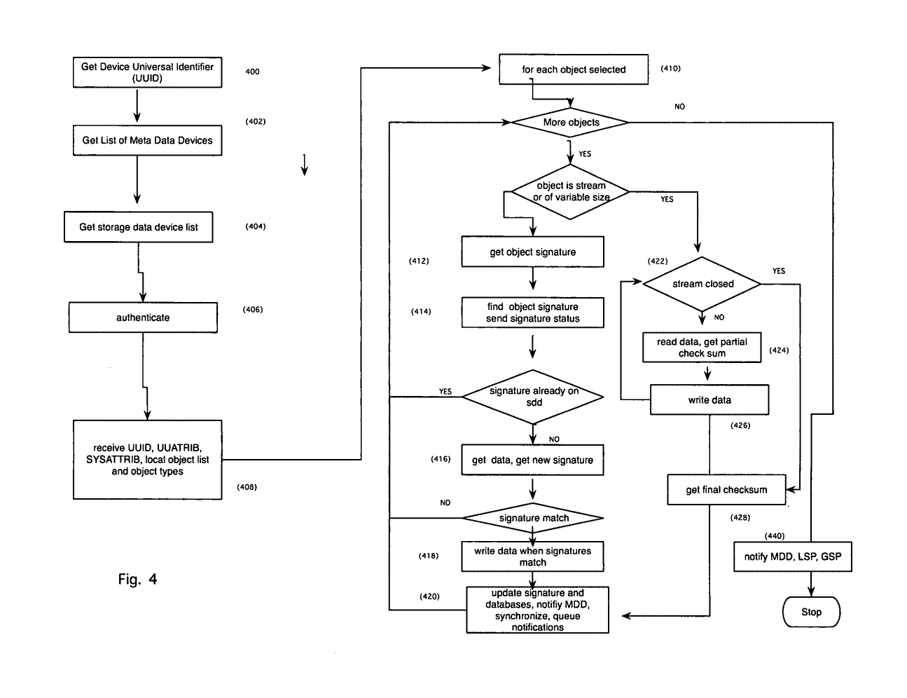

It is the primary object of the invention to implement a method and system for storing (FIG. 3) data objects, including streams of data and retrieving (FIG. 4) previously stored data objects, using one or more meta data devices and one or more storage data devices. The devices are interconnected using local area networks (110), WiFi, WiMax, private clouds (112), public clouds or other wide area networks such as the Internet (111) for example, or any medium capable of transmitting data between devices such as 3G, 4G or other wireless networks.

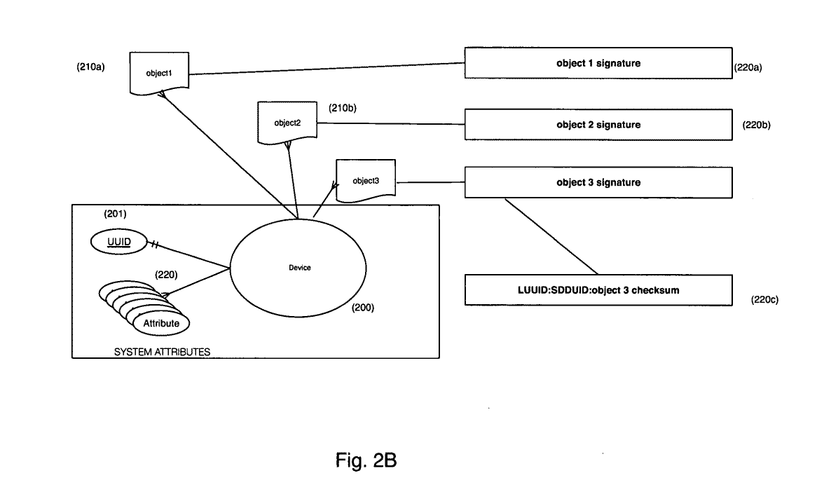

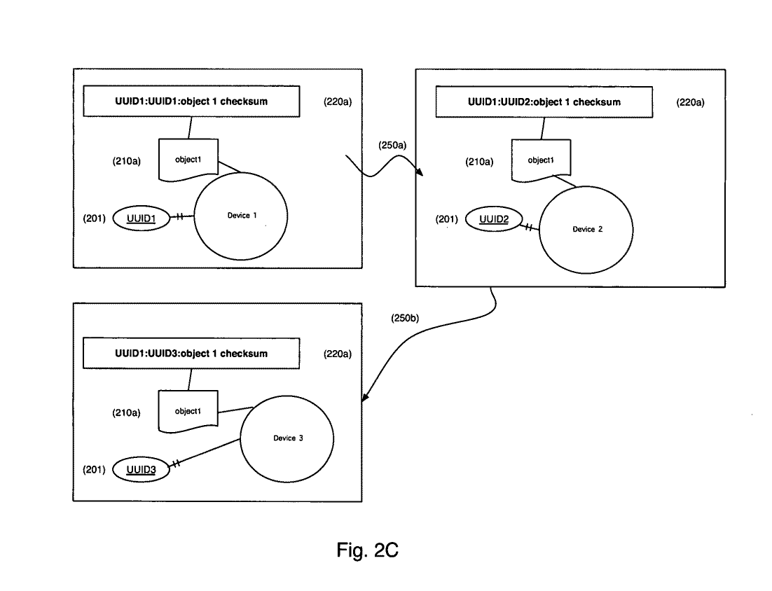

An example of a preferred embodiment of the present invention is illustrated in FIGS. 1 and 2 which show:
a. One or more source devices that need to archive data, search for data or patterns about data or in the data, or to retrieve data;
b. One or more storage data devices also known as SDD;
c. one or a plurality of meta data devices also known as MDD each performing several tasks for storing meta data, attributes, tags, searches;
d. that a device can be either a storage device, a meta data device or a dual purpose device playing the the role of a storage data device and meta data device.

Both the meta data and the storage data device need to have some memory some non volatile storage and run some operating system capable of managing input/output and network connectivity. A device may be a software layered on top of another device that provides memory and an operating system.

At the time of manufacturing or after installing the devices, a universal identifier (201) and a set of system attributes (220) are assigned to the system (200). A set of meta data to be collected are assigned (221). The device owner can add more user attributes (222) and assign new values to the attributes at run time. Certain attributes are mandatory and others are optional. A facility allows the device owner to specify which user attributes are optional and which are mandatory. An embedded database is used for the attributes. A user can assign a device to one or more local storage pools (190). A database provides the mapping between the universal identifiers, a logical name, the logical address and physical address of the device.

Several embedded databases are used to manage universal identifiers, object signatures, attributes and meta data, data about the devices are added to the system using several methods or a combination:
a. entered by the the device owner or manager into the database or memory;
b. discovered using multicast and entered into the database or memory;
c. fetched from discovered meta data devices or memory;
d. fetched from discovered storage data devices or memory;

Notably, the invention allows systems and devices to:
1. Read stored objects (211), read meta data, system attributes, read user defined attributes, generate a signature for the object (220c) and forward the object to one or more storage devices. When a storage device receives an object and its signature, it verifies that the signature matches what it should be and substitutes its own universal identifier for the storage data device identifier (220c), (220a).
2. Store data on multiple distributed heterogeneous devices (130) where the underlying storage can be a SAN (141), NAS, attached disk (140), USB stick, non volatile memory, etc and keep track of where they are (220c), (220a)
3. Keep track of where the objects are stored for later use or recovery from a disaster, or to track data leakage.
4. Forward objects to other storage devices for sharing or mirroring and or other indexing.
5. Search and locate objects using a distributed meta data device. Discover links, key words and attributes and notify interested processes or parties (502), (503), (511), (600), (601), (602), (603), (604).

Furthermore, in the present invention, each object has a signature that is both location and content dependent. The signature is a variable size and is made of several fragments or pieces that include one universal unique identifier that represents the source of the data, one unique universal identifier that represents the device on which the data is stored and the checksum of the content of the object. When an object is relocated, the universal identifier of the storage data object is updated to reflect where the object is stored.

The invention further allows systems to:
1. Tag objects and add attributes (FIG. 7).
2. Add new attributes, update existing ones (FIG. 7).
3. Add notifications to objects or groups of objects (503), (503). The notifications may be as simple as send email or SMS (510) to one or more persons when new data is available or to run a new process (512) who will execute other tasks as the user choses when new keywords are discovered in the content or in the attributes list or values. One can add an endless list of subscribers to the notification process.
4. Add a logging facility to track events such as addition of new data or discovery of new keywords in the attribute list or discovery of new devices.
5. Add warning notifications and alerts when objects with certain signatures are located. FIG. 2C shows a particular embodiment of the present invention. In this case an object signature is location dependent and is composed of several fragments that include at least the following:
   a. a fragment made up of a unique universal identifier that identifies the original source of the object;
   b. a fragment made up of a unique universal identifier of where the object is archived (storage data device)
e. a fragment made up of a check sum of the content of the object

FIG. 2C shows an example of where the unique universal identifier of the storage data device changes each time the same object is relocated or is stored on multiple storage data devices.

Storing objects on storage data devices:

FIG. 3 is a flow chart illustrating one embodiment of storing objects of fixed size and objects of unknown size.

To store an object or group of objects:
a. get the the local device universal identifier (300);
b. get the list of available meta data devices from the local database (302);
c. get the storage data device list;
d. choose a meta data device that is part of the local storage pool
e. connect to the meta data device and authenticate (306). In case of failure, go to the next meta data device and repeat step 306 until you get a valid token
f. collect user entered attributes (308)
g. collect local system attributes
h. send local universal identifier, list of objects, local object list and object types, attributes to the storage data device
i. For each selected object, generate an object signature, verify if it exists on the local storage pool, if it does not exist then send the data to the storage data device. The received data must match at least two fragments to be valid: The source unique universal identifier and the object content signature.
j. In the case of continuously streaming objects such as may be generated by some laboratory equipment, video recording, sensors etc, step (318) shows how a continuous stream of data is handled by the sender. Steps (422), (424), (426) and (428) show how the receiver handles continuous streams.

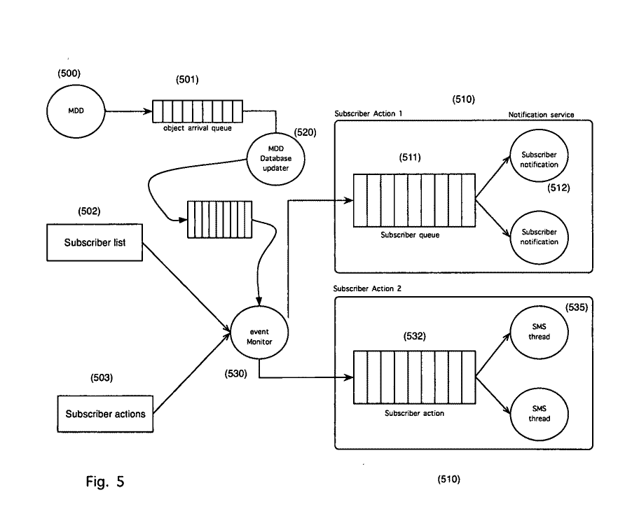

FIG. 4 and FIG. 5 illustrate how a storage data devices stores data and updates the various databases.

When a source device connects to the storage device, it authenticates it and verifies that the token it has gives it the right credentials for storing or searching. The storage device constantly updates the list of its peer meta data devices that are members of the same local and global storage pools. Once authentication is done, the following are some of the steps taken to store objects in a storage data device and update the databases:
a. receive source universal identifier, attributes, local object list
b. for each object that is not a stream:
c. receive the object signature, validate the signature and fail if the signature is invalid
d. receive the data and recompute the signature.
e. fail if the signature is invalid
f. update signature to update the universal identifier fragment for the storage data device
g. write object data to storage data device
h. update the database on the storage data device (420)
i. queue the update for the meta data device and any subscribers to notifications and alerts (420), (500), (501), (510)
j. When all objects are received the meta data devices are notified (440) and the databases updates are propagated across the local storage pools and global storage pools using data replication techniques or subscription schemes illustrated in FIG. 5.

Although the description above contains many specificities, these should not be construed as limiting the scope of the invention but as merely providing illustrations of some of the presently preferred embodiments of this invention. Various modifications may be implemented by those skilled in the arts of software without departing from the scope or spirit of the invention.

What is claimed is:

1. A method for archiving, retrieving, mining and delivering data objects using a distributed storage management system, the data objects are archived on one or more storage devices, each data object being represented on one or more meta data device databases by a dynamic location dependent object signature, said method comprising:
generating a unique source universal identifier for the source device whereby the said source contains or captures the data of the object to be archived or mined;
generating a unique universal identifier for the storage device where the object is stored;
generating a checksum signature of the content of the object;
concatenating the said universal identifiers at least with the checksum signature to obtain an object identifier signature whereby said object signature identifies where the object came from, the location where it is stored and the object content signature;

2. The Method according to claim 1 wherein one or more devices are assigned the role of meta data device or the role of a storage device or both meta data and storage device.

3. The method of claim 2 wherein one or more meta data devices and one or more storage devices are grouped to form a local storage pool.

4. The method of claim 3 wherein one ore more local storage pools are grouped to form a global storage pool.

5. The method of claim 2 further comprising:
a list of other meta data devices;
a list of storage data devices;
a list of local storage pools;
a list of global storage pools;
a list of storage devices in a local storage pool known as local storage peer list;
a list of storage devices in a global storage pool known as global storage peer list;
a list of meta data servers and storage data servers that form each local storage pool;
a list of access rights for each known local storage pool and global storage pool;
a list of tokens of membership in a local storage pool;
a list of tokens of membership in a global storage pool;

6. The method of claim 5 wherein the communication with a storage device requires the obtention of a valid token from a meta data device

7. The method of claim 5 wherein a device joins a local storage pool and global storage pool if he has a valid membership token.

8. The method according to claim 1 wherein object signatures are generated on the storage device, the source device or both, said storage devices comprising:
one or more databases to store object signatures;
one or more databases to store a list of devices in local storage pools;
one or more copies of the object data;
tokens of membership in a local storage pool;
tokens of membership in a global storage pool;
a database on persistent or volatile storage.

9. The method according to claim 1 wherein an object signature is stored on one or more storage devices and on at least one meta data device.

10. The method of claim 1 wherein a database associates the source universal id, the storage universal identifier and the meta data universal identifier with physical and logical addresses of the device

11. The method of claim 1 wherein a source device saves a collection of attributes on the storage device.

12. The method of claim 11 comprising:
a means for generating new attributes and attribute values by the device operator
a means for selection and collection of one or more user selected attributes and their values;
a means for generation of source device system attributes and their values;
a means for generation of object meta data;
a means for sending the said attributes, attribute values and meta data as a collection to the storage device;
associating the content of said collection with the object signature, indexing the received data on an attribute database on the storage device;
re-indexing one or more sections of the data object;

13. A method as recited in claim 11 wherein:
storage data device updates the object signature each time it receives a new object;
the said update consists at least of overwriting the storage data device universal identifier with the current storage data device universal identifier;

14. The method of claim 12 wherein the storage device synchronizes the attribute data base on the storage device with one or more meta data devices.

15. The method of claim 12 wherein a user can select attributes and values from an existing set or makes new ones in any language, dialect or symbol.

16. A method as recited in claim 12 wherein a user can search on objects or groups of objects using any combination of attributes and attribute values

17. A method where a user can locate and retrieve an object or its meta data or attributes and attribute values comprising:
query the meta data device using one or more stored attributes or metadata.
receive a selection set that includes an object signature, attributes and meta data
break the signature into fragments to extract the source universal identifier, the storage device universal identifier and the file object checksum;
use the database and get the logical address of said storage device universal identifier;
use the database and get the ordered global storage device peer list of the said logical address;
use the ordered global storage peer list to get the one or more sections of the data object from one or more storage data device peers.
order the preferences of meta data devices and storage data devices using one or more of the hit ratios, response times, availability, failure rate, load factors.

18. The method of claim 17 wherein each transaction to initiate a read, search creates a log comprising:
source device system information;
source device access token;
a geo-reference of objects;
access times

19. A system and method as recited in claim 12 wherein authorized users can add subscriptions to receive notifications when databases are updated or when certain attributes or values change in the archival systems.

20. A system and method according to claim 19 wherein further comprising:
one or more lists of repositories of key words;
one or more conditions and notifications to trigger events;
one or more processes analyzing the database for said key words, objects, source universal identifiers, storage universal identifiers;
one or more processes analyzing the object signature;
one or more processes analyzing attribute values;
one or more processes relaying notifications to users contacts or processes

21. The method of claim 1 where the object signature is encrypted.
